(19) United States
(12) Patent Application Publication
(10) Pub. No.: US 2008/0116848 A1
(43) Pub. Date: May 22, 2008

(54) Power supply system

(75) Inventor: Sheng-Feng Chen, Taipei Shien (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/808,495

(22) Filed: Jun. 11, 2007

(30) Foreign Application Priority Data
Nov. 17, 2006 (TW) 095142692

(51) Int. Cl. H02J 7/00; H02J 7/02

(52) U.S. Cl. 320/112

(57) ABSTRACT

The invention discloses a power supply system for charging a rechargeable battery in a portable electronic device. The power supply system of the invention redefines an output curve of a power adapter, such that the power adapter can work in a maximum power region for a long time. When a system current plus a charging current exceed a maximum current limit of the power adapter, the power supply system of the invention will automatically lower the current for charging a battery, so as to prevent the power adapter from being shut down.

### BACKGROUND OF THE INVENTION

1. Field of the Invention

The invention relates to a power supply system and, more particularly, relates to a power supply system for charging a battery in a portable electronic device. When a system current plus a charging current exceed a maximum current limit of a power adapter, the power supply system of the invention will automatically reduce the current for charging the battery, so as to prevent the power adapter from being shut down.

2. Description of the Prior Art

In general, a portable electronic device (e.g. notebook) usually has a rechargeable battery. When the portable electronic device can not be supplied with power by a traditional power socket, it will be supplied with power by the battery to keep working.

Referring to the FIG. 1, FIG. 1 is a schematic diagram illustrating a circuit of a power supply system 1 of the prior art. As shown in FIG. 1, when there is a traditional power socket, users can use an AC/DC adapter 10 to supply power for operating a system load 12 of a portable electronic device 2. Additionally, the AC/DC adapter 10 can also supply power for charging a battery 16 by a DC/DC converter 14.

As shown in FIG. 1, an input current I1 supplied by the AC/DC adapter 10 comprises a system current I2 and a charging current I3. A constant power circuit 17 of the power supply system 1 has a resistance R1 for detecting the input current I1. When the system current I2 increases, the input current I1 increases as well. Therefore, the voltage drop of the resistance R1 achieves a default value VR1. Afterward, an operational amplifier 18 outputs signals to reduce the charging current I3, such that the input current I1 will not exceed the default value. In other words, the maximum output current of the AC/DC adapter 10 is first used for supplying the system current I2, the remaining current is then used for supplying the charging current I3. However, since the power supply system 1 has to utilize the constant power circuit 17 to control the input current I1, the circuit design thereof is more complex.

Referring to FIG. 2, FIG. 2 is a schematic diagram illustrating an output curve of the AC/DC adapter 10 shown in FIG. 1. In general, an output voltage of the AC/DC adapter 10 is constant. In other words, under normal situation, the AC/DC adapter 10 will work in a constant voltage region, as shown in FIG. 2. When a load is extraordinary large, the AC/DC adapter 10 will work in a protection against overload region. At the same time, the output voltage decreases while the output current increases. At last, the AC/DC adapter 10 will be shut down. In prior art, the minimum output voltage of the AC/DC adapter 10 usually does not be defined. Additionally, the protection against overload region is a protection against overload current, so the difference of protection against overload current between AC/DC adapters 10 is large, as lines S and T shown in FIG. 2. The AC/DC adapter 10 is usually protected by a primary circuit to be against overload and does not damage itself at a minimum cost. Therefore, the AC/DC adapter 10 cannot work in the protection against overload region for a long time.

Referring to FIG. 1, the traditional power supply system 1 further comprises an ID detector 20 for detecting an ID signal provided by different AC/DC adapter 10 with different power. According to different ID, the ID detector 20 will output a corresponding signal variation VR1, such that the power supply system 1 can co-operate to different AC/DC adapter 10 with different power. However, the ID detector 20 increases the cost of the power supply system 1.

In short, the traditional power supply system 1 has the following disadvantages of: 1) a more complex circuit design; 2) unable to work in the protection against overload region for a long time, so the maximum power of the AC/DC adapter 10 can not be fully utilized; and 3) a higher cost, if the power supply system 1 is equipped with the ID detector 20. Therefore, the scope of the invention is to provide a power supply system for solving the aforesaid problems.

### SUMMARY OF THE INVENTION

A scope of the invention is to provide a power supply system which re-defines an output curve of an AC/DC adapter, such that the AC/DC adapter can work in a maximum power region for a long time. Accordingly, the circuit design of the power supply system is simplified.

According to a preferred embodiment, the power supply system of the invention is used for charging a battery in a portable electronic device. The power supply system comprises a power adapter and a charging current converter. The power adapter is used for supplying an input current. The input current comprises a system current and a charging current. The system current is used for operating the portable electronic device, and the charging current is used for charging the battery. The power adapter defines a first working region and a second working region. A minimum output voltage is set in the second working region. The power adapter supplies a constant output voltage in the first working region and a decreased output voltage in the second working region, wherein the decreased output voltage decreases from the constant output voltage to the minimum output voltage.

In the aforesaid embodiment, when the input current exceeds a maximum current limit of the power adapter, an output voltage corresponding to the input current starts to decrease according to the decreased output voltage in the second working region. Further, an input voltage of the charging current converter decreases to decrease the charging current. Accordingly, when the portable electronic device is turned on, the maximum output current of the AC/DC adapter is first used for supplying the system current, and the remaining current is then used for supplying the charging current.

Therefore, since the power supply system of the invention is not equipped with a constant power circuit, the circuit design is simplified. Additionally, according to the power supply system of the invention, the portable electronic device can co-operate to different AC/DC adapter with different power without an ID detector. Consequently, the cost is reduced.

The advantage and spirit of the invention may be understood by the following recitations together with the appended drawings.

### BRIEF DESCRIPTION OF THE APPENDED DRAWINGS

FIG. 1 is a schematic diagram illustrating a circuit of a power supply system 1 of the prior art;

FIG. 2 is a schematic diagram illustrating an output curve of the AC/DC adapter 10 shown in FIG. 1;

FIG. 3 is a schematic diagram illustrating a circuit of a power supply system 3 according to a preferred embodiment of the invention;

FIG. 4 is a schematic diagram illustrating an output curve of the power adapter 30 shown in FIG. 3;

FIG. 5 is a schematic diagram illustrating a circuit of the power adapter 30 shown in FIG. 3; and

FIG. 6 is a timing diagram illustrating the power supply system 3 shown in FIG. 3 during practical operation.

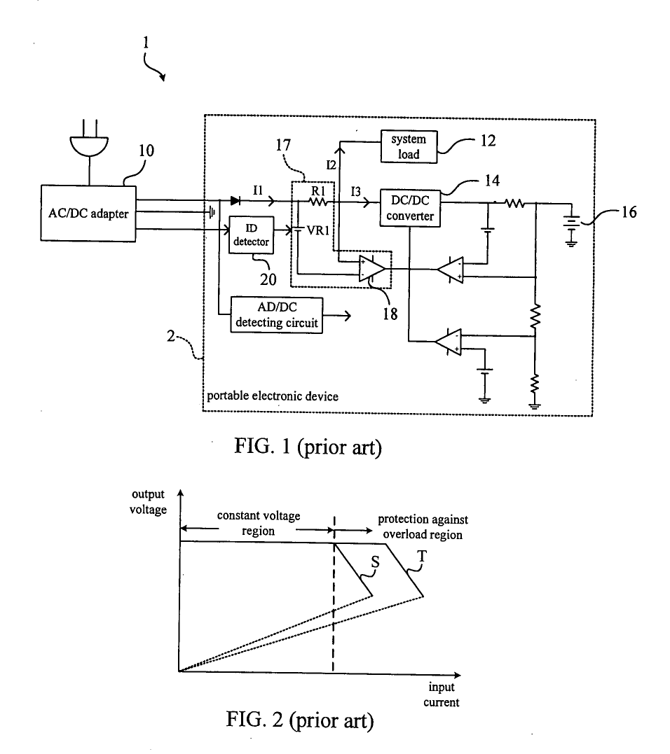

### DETAILED DESCRIPTION OF THE INVENTION

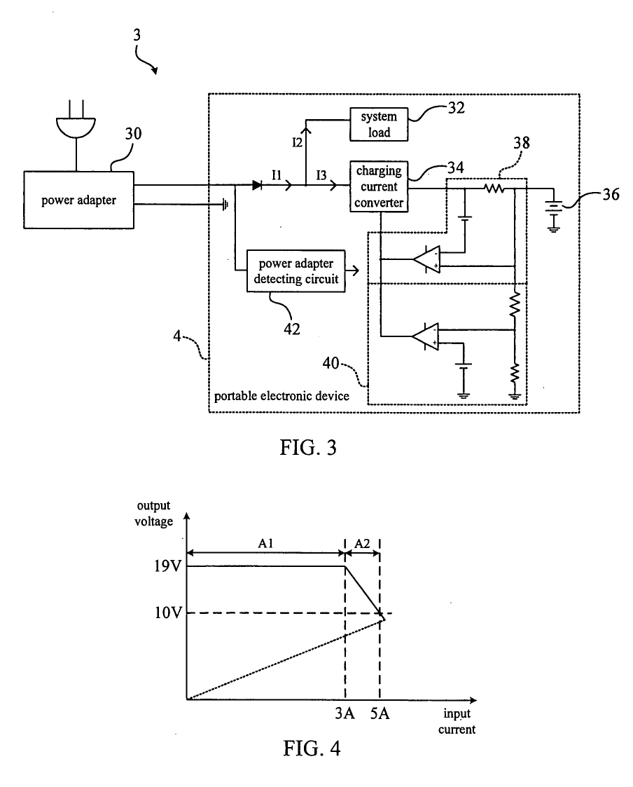

Referring to FIG. 3, FIG. 3 is a schematic diagram illustrating a circuit of a power supply system 3 according to a preferred embodiment of the invention. The power supply system 3 is used for charging a battery 36 in a portable electronic device 4. In this embodiment, the power supply system 3 comprises a power adapter 30, a charging current converter 34, a constant current circuit 38, a constant voltage circuit 40, and a power adapter detecting circuit 42. The portable electronic device 4 can be a notebook, a laptop, or the like. The power adapter 30 can be an AC/DC adapter, and the charging current converter 34 can be a DC/DC converter. The constant current circuit 38 is coupled between the battery 36 and the charging current converter 34. The constant voltage circuit 40 is also coupled between the battery 36 and the charging current converter 34. The power adapter detecting circuit 42 is coupled between the power adapter 30 and the charging current converter 34. In this embodiment, the voltage of the power adapter detecting circuit 42 is set to be lower than the minimum voltage of the battery 36.

As shown in FIG. 3, the power adapter 30 is used for supplying an input current I1. The input current I1 comprises a system current I2 and a charging current I3. The system current I2 is used for supplying power for operating a system load 32 of the portable electronic device 4, such that a user can operate the portable electronic device 4. Additionally, the charging current I3 is used for charging the battery 36.

Referring to FIG. 4, FIG. 4 is a schematic diagram illustrating an output curve of the power adapter 30 shown in FIG. 3. As shown in FIG. 4, the output curve of the power adapter 30 defines a first working region A1 and a second working region A2. A minimum output voltage is set in the second working region A2. The power adapter 30 supplies a constant output voltage in the first working region A1 and a decreased output voltage in the second working region A2. The decreased output voltage decreases from the constant output voltage to the minimum output voltage. In other words, the first working region A1 represents a constant voltage region of the power adapter 30, and the second working region A2 represents a maximum power region of the power adapter 30.

In this embodiment, the minimum output voltage is set to be 10V, and the constant output voltage is set to be 19V. Therefore, the decreased output voltage decreases from 19V to 10V, as shown in FIG. 4.

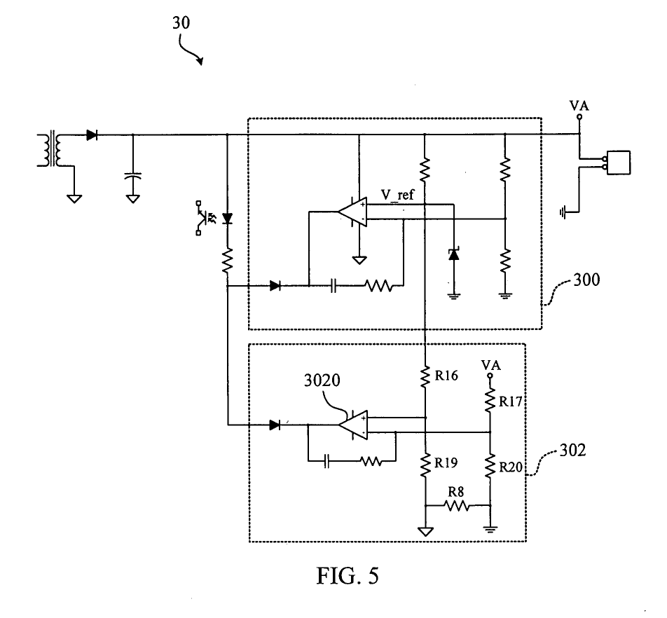

Referring to FIG. 5, FIG. 5 is a schematic diagram illustrating a circuit of the power adapter 30 shown in FIG. 3. In this embodiment, the power adapter 30 comprises a voltage feedback circuit 300 and a current feedback circuit 302. The voltage feedback circuit 300 is used for stabilizing an output voltage and providing a reference voltage. The current feedback circuit 302 is used for adjusting the maximum current limit of the power adapter 30 according to the reference voltage. It should be noticed that the current feedback circuit 302 is embedded in a secondary circuit of the power adapter 30.

As shown in FIG. 5, the voltage feedback circuit 300 supplies a reference voltage V_ref. After acquiring the reference voltage V_ref, the current feedback circuit 302 utilizes voltage-dividing resistances R17 and R19 to connect with a non-inverting input end of an operation amplifier 3020. Afterward, a resistance R8 responsible for detecting an output current connects with an inverting input end of the operation amplifier 3020 through a resistance R20. At last, an output voltage VA is adjusted by a resistance R17, such that the maximum power limit is achieved.

For example, if the reference voltage V_ref is set to be 2.5V, the resistance R16 is set to be 16.36 KΩ, and the resistance R19 is set to be 1 KΩ, a voltage of the non-inverting input end of the operation amplifier 3020 is 2.5V/(R16+R19)*R19=0.144V. Additionally, if the resistance R17 is set to be 224 KΩ, the resistance R20 is set to be 1 KΩ, and the resistance R8 is set to be 20 mΩ, the output current can be calculated by the following formula 1.

the output current=(0.144V−(VA/(R17+R20)*R20))/R8. Formula 1

Therefore, when the output voltage VA is set to be 19V, the output current will be 3A; when the output voltage VA is set to be 10V, the output current will be 5A, as the output curve shown in FIG. 4. Accordingly, designers can adjust the output curve of the power adapter 30 according to practical demands.

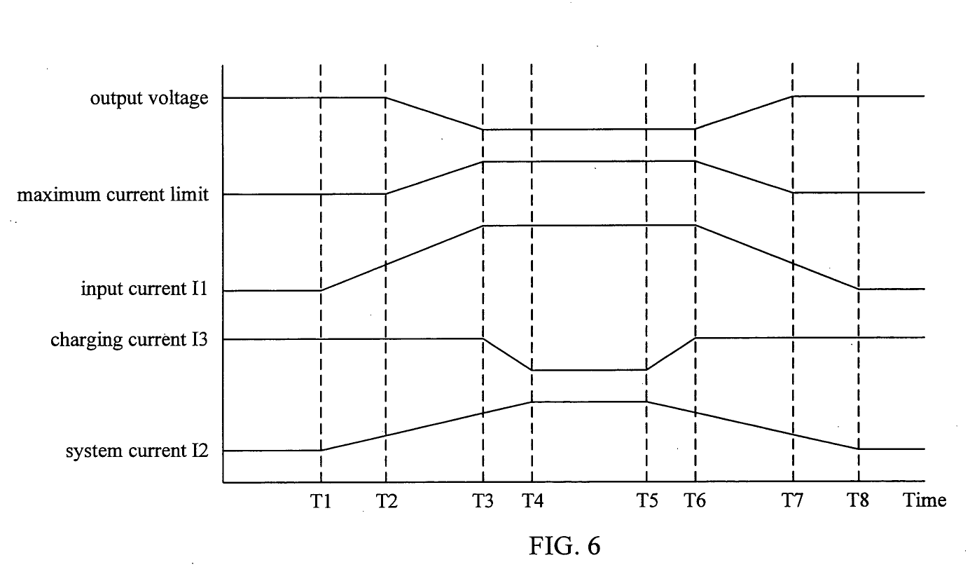

Referring to FIG. 3, FIG. 4, and FIG. 6, FIG. 6 is a timing diagram illustrating the power supply system 3 shown in FIG. 3 during practical operation.

At time T1, the system current I2 starts to increase.

At time T2, the input current I1 achieves the maximum current limit (e.g. 3A shown in FIG. 4) of the power adapter 30, and the output voltage of the power adapter 30 starts to decrease.

During time T2-T3, the output voltage of the power adapter 30 starts to decrease, and the maximum current limit of the power adapter 30 starts to increase (e.g. from 3A to 5A shown in FIG. 4).

At time T3, the output voltage of the power adapter 30 nearly drops to the voltage of the battery 36. The input voltage of the charging current converter 34 decreases, such that a default charging current can not be achieved. Therefore, the charging current I3 starts to decrease.

During time T3-T4, the system current I2 continuously increases, so the charging current I3 decreases. Therefore, the input current I1 is equal to the maximum current limit of the power adapter 30.

During time T4-T5, the charging current I3 is equal to the maximum current limit (i.e. the input current I1) of the power adapter 30 minus the system current I2. In other words, the current remained after consumption of the system load 32 of the portable electronic device 4 is used for charging the battery 36.

At time T5, the system current I2 starts to decrease.

During time T5-T6, the system current I2 continuously decreases, so the charging current I3 increases. Therefore, the input current I1 is equal to the maximum current limit of the power adapter 30.

At time T6, the charging current I3 achieves a default value and stops to increase.

During time T6-T7, the system current I2 continuously decreases. Since the input current I1 is lower than the maximum current limit of the power adapter 30, the output voltage of the power adapter 30 starts to increase again.

At time T7, the output voltage of the power adapter 30 increases to a maximum voltage.

During time T7-T8, the system current I2 continuously decreases, and the charging current I3 keeps constant. Therefore, the input current I1 is lower than the maximum current limit of the power adapter 30.

In short, when the input current I1 (i.e. the system current I2 plus the charging current I3) is exceeding the maximum current limit of the power adapter 30, the power supply system 3 of the invention will automatically decrease the charging current I3. Accordingly, when the portable electronic device 4 is turned on, the power remained after consumption of the system load 32 can be fully supplied for charging the battery 36.

Referring to the following Table 1 and Table 2, Table 1 shows comparison of an AC/DC adapter (a power adapter) between the invention and prior art, and Table 2 shows comparison of a portable electronic device between the invention and prior art.

TABLE 1

| AC/DC adapter | Prior art | The invention |
|---|---|---|
| voltage feedback circuit | includes | includes |
| current feedback circuit | not necessary | necessary |
| whether the adapter can | no | yes |
| work in the maximum | | |
| power region for a long | | |
| time | | |
| output voltage under | keeps constant | decreases after |
| normal situation | | achieving the |
| | | maximum current limit |
| where is the current | primary or secondary | secondary circuit |
| feedback circuit | circuit | |
| embedded | | |
| minimum output voltage | not defined | need to define |

TABLE 2

| Portable electronic | | |
|---|---|---|
| device | Prior art | The invention |
| constant power circuit | includes | not include |
| ID detecting circuit | depends on practical | not include |
| | demand | |
| voltage detecting point | higher than the | lower than the |
| of AC/DC adapter | maximum voltage of | minimum voltage of |
| | the battery | the battery |
| input voltage under | keeps constant | decreases after |
| normal situation | | achieving the |
| | | maximum current limit |
| charging current | linear or switch mode | linear or switch mode |
| converter | | |

Compared to the prior art, since the power supply system of the invention is not equipped with the constant power circuit, the circuit design is simplified. Additionally, according to the power supply system of the invention, the portable electronic device can co-operate to different AC/DC adapter with different power without an ID detector. Therefore, the cost is reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A power supply system for charging a battery in a portable electronic device, comprising:
a power adapter for supplying an input current, the input current comprising a system current for operating the portable electronic device and a charging current for charging the battery, the power adapter defining a first working region and a second working region, a minimum output voltage being set in the second working region, the power adapter supplying a constant output voltage in the first working region and a decreasing output voltage in the second working region, the decreasing output voltage decreasing from the constant output voltage to the minimum output voltage; and
a charging current converter, coupled between the power adapter and the battery, for receiving the charging current and then charging the battery,
wherein when the input current exceeds a maximum current limit of the power adapter, according to the decreasing output voltage of the second working region, an output voltage of the power adapter corresponding to the input current starts to decrease, so that an input voltage of the charging current converter decreases to decrease the charging current.

2. The power supply system of claim 1, wherein the power adapter is an alternating current/direct current (AC/DC) adapter.

3. The power supply system of claim 1, wherein the charging current converter is a DC/DC converter.

4. The power supply system of claim 1, wherein when the output voltage of the power adapter starts to decrease, the maximum current limit of the power adapter starts to increase.

5. The power supply system of claim 1, further comprising a constant current circuit coupled between the battery and the charging current converter.

6. The power supply system of claim 1, further comprising a constant voltage circuit coupled between the battery and the charging current converter.

7. The power supply system of claim 1, further comprising a power adapter detecting circuit coupled between the power adapter and the charging current converter.

8. The power supply system of claim 7, wherein a voltage of the power adapter detecting circuit is set to be lower than the minimum voltage of the battery.

9. The power supply system of claim 1, wherein the power adapter comprises:
a voltage feedback circuit for stabilizing the output voltage of the power adapter and for providing a reference voltage; and
a current feedback circuit for adjusting the maximum current limit of the power adapter according to the reference voltage.

10. The power supply system of claim 9, wherein the current feedback circuit is embedded in a secondary circuit of the power adapter.
